(19) United States
(12) Patent Application Publication
(10) Pub. No.: US 2005/0030610 A1
(43) Pub. Date: Feb. 10, 2005

(54) Process for producing display device particles, display device particles, and image-display medium and image-forming device using the same

(75) Inventors: Hidehiko Soyama, Minamiashigara-shi (JP); Satoshi Hiraoka, Minamiashigara-shi (JP); Yasuo Yamamoto, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/796,019

(22) Filed: Mar. 10, 2004

(30) Foreign Application Priority Data
Aug. 8, 2003 (JP) 2003-289794

(51) Int. Cl. G03G 9/00; G02B 26/00

(52) U.S. Cl. 359/296

(57) ABSTRACT

The present invention provides a process for producing display device particles having positive or negative chargeability and having color, including: at least an emulsification step in which calcium carbonate is added as an emulsifying auxiliary to a display device particle-forming composition that contains a colorant and a polymerizable monomer or a resin, wherein the emulsifying auxiliary is calcium carbonate coated with a hydrophilic organic material, an average dispersed particle size of the emulsifying auxiliary present in an aqueous medium ranges from 0.05 to 1 μm, a variation coefficient of the dispersed particle sizes is 60% or less, and an electric field generating unit is provided to generate an electric field corresponding to the image.

### CROSS-REFERENCE TO RELATED APPLICATION

This application claims priority under 35 USC 119 from Japanese Patent Application No. 2003-289794, the disclosure of which is incorporated by reference herein.

### BACKGROUND OF THE INVENTION

1. Field of the Invention

The present invention relates to a process for producing display device particles (i.e., particles for a display device), display device particles obtained by this production process, as well as to a repeatedly rewritable image-display medium and an image-forming device using the same.

2. Description of the Related Art

As repeatedly rewritable image-display media, display techniques proposed hitherto include a twisting ball display (display utilizing rotation of particles having two separate colors), electrophoresis, magnetophoresis, thermally rewritable media, liquid crystals having memorizing ability, and the like. Such display techniques are excellent in image memorizing ability, but they have entailed problems insofar that the display has not been able to produce paper-like white color at its surface, and density contrast of images has been low.

In order to solve the above-mentioned problems, a display technique using a toner has been proposed. In this technique, a conductive colored toner and white particles are used to exhibit contrast, and thereby display images. In more detail, the conductive colored toner and the white particles are sealed in a void between electrode substrates facing each other, and electric charges are applied on the conductive colored toner through a charge transporting layer deposited on an inner surface of the non-display side of the electrode substrate, such that the charge-introduced conductive colored toner can migrate, via an electric field applied across the two electrode substrates, toward the display side of the electrode substrate, positioned opposite the non-display side of the electrode substrate, and thereby reach, and adhere to, the inside of the display side of the electrode substrate (see Japan Hardcopy '99, pp.249-252).

This display technique, in which the image-display medium is made entirely of solid materials, is excellent insofar that displays of white-color and displays of black-color can in principle be completely interchanged. This technique, however, also entails drawbacks insofar that some of the conductive colored toner particles do not contact the charge transporting layer deposited on the inner surface of the non-display side of the electrode substrate, and that other conductive colored toner particles are produced which are isolated from the other conductive colored toner particles. But of these types of conductive colored toner particles cannot migrate, via the electric field, since no electric charges are applied on the toner particles. As a result, toner particles appeared at random between the two electrode substrates, causing a problem of diminished contrast density.

As an image-display medium using particles and excellent in density contrast, an image-display medium has also been proposed which comprises a pair of substrates and uses plural kinds of particles that have mutually different colors and charging characteristics, and are sealed in a void between the pair of substrates to allow migration between the substrates via an applied electric field (see Japanese Patent Application Laid-Open (JP-A) No. 2001-312225). This proposed technique has produced high-grade whiteness and high density contrast. The particles used in this image-display medium have been able to produce, at an initial stage, excellent white density, black density and density contrast. However, when images have repeatedly been rewritten over a long term, image density has been reduced, thereby leading to a decrease in density contrast, or to a lack of image uniformity, and thus on occasions causing image unevenness.

As a way of producing image-display particles to be sealed in these image-display media, a process involving an emulsification step is known. However, by means of this emulsification step in which calcium carbonate has been used as an emulsifying auxiliary in order to obtain a narrow particle size distribution of an emulsified product, in practice it has not proved possible to narrow down even when such techniques have been used. Accordingly, a proposal has been made to narrow down this particle size distribution by using a membrane-emulsifier (see JP-A No. 2002-202531). However, satisfactory results have still not yet been attained through the use of this method.

Phenomena such as the lack of uniformity in image contrast or density, when rewriting is repeatedly performed over a long term, or the lowering of image density and reductions in density contrast leading to unevenness in images, can all be attributed to the fact that the particle size distribution of the image-display particles sealed in the image-display medium (i.e., the display device particles) is too broad.

In other words, in a case where particle size distribution in a smaller size range is too broad, an agglomerating force between the particles is too strong, in an image-forming device, the particles cannot be sufficiently separated from each other by an electric field. As in consequence, a sufficient density contrast cannot be obtained. On the other hand, in a case where particle size distribution in a relatively larger size range is too broad, unevenness is generated in the image density and in consequence, uniformity of display cannot be obtained; or alternatively, at the time of display, the particles will collide against a display surface, whereby the particles are deformed, and easily adhere to the display surface. Thus, the particles are not separated from the surface, and hence, a sufficient image density contrast cannot be obtained.

On the other hand, the particle size distribution of the display device particles is largely influenced by the process for producing the particles, that is, it significantly reflects the particle size distribution of an emulsified product generated during an emulsification step. Accordingly, in order to obtain display device particles having a narrow particle size distribution, it is necessary to narrow down the particle size distribution of the emulsified product generated during the emulsification step.

### SUMMARY OF THE INVENTION

The present invention has been made in view of the above circumstances and provides a process for producing display device particles having a narrow particle size distribution, display device particles obtained by this production process, as well as an image-display medium and an image-forming device using the display device particles.

For the purpose of solving the aforementioned problems, the present inventors conducted extensive research and discovered that, in order to narrow down the particle size distribution of the emulsified product, it is necessary to control both a dispersed particle size and a particle size distribution of calcium carbonate that is used as an emulsifying auxiliary and is present in an aqueous phase. The inventors also discovered that in order to control the dispersed particle size and the particle size distribution of calcium carbonate present in an aqueous phase, it is necessary to coat calcium carbonate with a hydrophilic organic material.

Furthermore, the inventors discovered that it is desirable to regulate a central particle size of the emulsified product and that for such a purpose it is preferable to control both the amount of calcium carbonate coated with the hydrophilic organic material and an emulsifying rate.

Moreover, the inventors discovered that in order to improve electrical chargeability of display device particles, it is desirable to remove the above-mentioned calcium carbonate from the emulsified product obtained through the emulsification step.

According to a first aspect of the invention, a process is provided for producing display device particles having positive or negative chargeability and having color, a process which comprises at least an emulsification step in which calcium carbonate is added as an emulsifying auxiliary to a display device particle-forming composition that contains at least a colorant and a polymerizable monomer or a resin, wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less.

According to a second aspect of the invention, display device particles are provided having positive or negative chargeability and having color, display device particles are produced through at least an emulsification step in which calcium carbonate is added as an emulsifying auxiliary to a display device particle-forming composition that contains at least a colorant and a polymerizable monomer or a resin, wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less.

According to a third aspect of the invention, an image-display medium is provided which comprises a pair of substrates arranged to face each other, and particle groups made up of two or more kinds of particles and sealed in a void between the pair of substrates, in which at least one of the particle groups has positive chargeability, at least one of the other particle groups has negative chargeability, and the at least one of the former particle groups and the at least one of the latter particle groups have mutually different colors, wherein the particles having positive and negative chargeability are produced through at least an emulsification step in which calcium carbonate is added as an emulsifying auxiliary to a display device particle-forming composition that contains at least a colorant and a polymerizable monomer or a resin, and wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less.

According to a fourth aspect of the invention, an image-forming device is provided for forming an image in an image-display medium which comprises a pair of substrates arranged to face each other, and particle groups made up of two or more kinds of particles and sealed in a void between the pair of substrates, in which at least one of the particle groups has positive chargeability, at least one of the other particle groups has negative chargeability, and the at least one of the former particle groups and the at least one of the latter particle groups have mutually different colors, wherein the particles having positive and negative chargeability are produced through at least an emulsification step in which calcium carbonate is added as an emulsifying auxiliary to a display device particle-forming composition that contains at least a colorant and a polymerizable monomer or a resin, wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less, and wherein an electric field generating unit is provided in order to generate, in the void between the pair of substrates, an electric field corresponding to the image.

### BRIEF DESCRIPTION OF THE DRAWINGS

FIG. 1 is a schematic structural view illustrating an example of an image-forming device using an image-display medium.

FIG. 2 is a sectional view of the image-forming device illustrated in FIG. 1, taken along a section line A-A.

FIG. 3 is a graph showing a variation coefficient of calcium carbonate and particle size distribution of all the produced particles.

### DETAILED DESCRIPTION OF THE INVENTION

The present invention will be described in more detail hereinafter.

(Image-Display Medium and Image-Forming Device)

First, description is given of the structures and effects each of an image-display medium and an image-forming device using display device particles obtained by the process for producing display device particles of the invention, which will be described later.

The image-display medium is a medium comprising a pair of substrates arranged to face each other, and particle groups made up of two or more kinds of particles and sealed in a void between the pair of substrates, in which at least one of the particle groups has positive chargeability, at least one of the other particle groups has negative chargeability, and the at least one of the former particle groups and the at least one of the latter particle groups have mutually different colors.

Sealing of the particles into this image-display medium is performed through the following processes. First, the two or more kinds of particles, which are sealed into the void between the pair of substrates arranged to face each other, are mixed at a prescribed ratio in a mixing container, and then stirred. It is considered that in this mechanical mixing and stirring step, frictional electrification is caused between the respective particles and between the particles and the inner wall of the container, whereby the respective particles are electrically charged. Thereafter, the mixed particles are sealed into the void between the pair of substrates so as to give a specific volume filling ratio.

It is necessary that at least one of the two or more kinds of particles used in the image-display medium is controlled to have positive chargeability, while at least one of the other is controlled to have negative chargeability. When different two kinds of particles collide with each other or are subjected to rubbing with each other to have triboelectricity, the one is positively charged and the other is negatively charged depending on a positional relationship between the two kinds of particles with respect to tribo series. For example, if a suitable charge controlling agent is selected, it is possible to adjust this tribo series appropriately.

Image formation in this image-display medium can be attained by use of an image-forming device comprising, between the pair of substrates to constitute the image-display medium, an electric field generating unit for generating an electric field corresponding to the image.

First, by using the electric field generating unit, polarity of a DC voltage applied between the pair of substrates is switched over or an alternative voltage is applied, such that the sealed particles reciprocate between the substrates in accordance with the electric field (an initializing step). It is considered that in this initializing step, the respective particles collide with each other or the particles collide against the substrate surface, to thereby confer frictional electricity on the particles. (As used herein, a term “substrate surface” refers to a surface of a substrate to face the other substrate, which is oppositely arranged, unless otherwise specified.). Through this initializing step, the particles acquire desired frictional electrification quantities.

By the above-mentioned frictional electrification, at least one kind of the plural kinds of particles is positively charged (the positively-charged particles may be referred to as “the first particles” hereinafter). At least one kind of the other is negatively charged (the negatively-charged particles may be referred to as “the second particles” hereinafter). At this time, by Coulomb force effected between the first particles and the second particles, the particles will adhere to each other and agglomerate. However, the first particles are separated from the second particles in a direction of the electric field applied finally in the initializing step. As a result, the first particles adhere to one of the two substrates, while the second particles adhere to the other.

Next, an electric field is applied to the medium in accordance with image signals, whereby the group of the first particles and that of the second particles are separated from each other, migrate and then adhere to the mutually different substrates. In more detail, when the electrostatic force acting on the individually electrified particles becomes larger than Coulomb force between the respective particles, than a force effected between the particles and the substrate surfaces, or than a force based on the contact potential difference therebetween by the electric field applied from the outside, it is considered that the first and second particle groups are separated from each other, migrate and then adhere to the opposite substrates. It is also considered that the particles adhered to the respective substrate surfaces are fixed thereto by mirror image force or van der Waals force generated between the particles and the substrate surfaces.

In case where agglomerating properties between the respective particles are high, an agglomerating force between the particles becomes high, and hence the particles are not easily separated from each other. On the other hand, if energy generated when the display device particles collide against a display surface is too large, the particles are deformed to thereby adhere to the display surface. In both the cases, a sufficient image density contrast cannot be obtained.

On the other hand, when the particle size distribution in the relatively smaller particle range is narrow, an agglomerating force between the particles is reduced. When the particle size distribution in the relatively larger particle range is narrow, colliding energy is suppressed. Accordingly, a sufficient image density contrast can be obtained if the particle size distribution of the particles is made narrow.

Even if the central particle size of the particles is too small, the same results as obtained when the particle size distribution in the relatively smaller particle range is broad may be produced. Also, even if the central particle size of the display particles is too large, the same results as obtained when the particle size distribution in the relatively larger particle range is broad may be produced. Therefore, it is necessary to make the central particle size of the particles having positive or negative chargeability fall within an appropriate range, and it is preferable to make the central particle size fall within a range of from 3 to 30 μm.

In other words, in case where an image is formed using the above-described image-display medium, it is important to make the particles exhibiting positive or negative chargeability have a narrow particle size distribution and an appropriate central particle size.

Such particles capable of exhibiting positive or negative chargeability, also having a narrow particle size distribution and an appropriate central particle size, can readily be obtained by the process for producing display device particles of the invention, which will be describe later. If the display device particles obtained by this production process are used to produce an image-display medium having the above-described feature, image contrast is high and image density is uniform. Further, even if repeatedly rewriting is performed over a long term, decreases in image density, density contrast and image uniformity is suppressed, to thus maintain good image quality.

The above description is based on a prerequisite that each of the positively-charged particle groups and the negatively-charged particle groups is made up of particles of one kind. However, each of the two groups may be made up of particles of two or more kinds. Even in the case where two or more kinds are used, images can be formed by the same mechanism as described above.

In order to enhance density contrast, it is more preferable that either one of the particle groups having positive charging ability and negative charging ability has white color.

-Structure of Substrates-

The substrates used in the image-display medium are a pair of substrates arranged to face each other. The above-mentioned particles are sealed into the void between the pair of substrates. The substrates used in the image-display medium are in the shape of a plate having electric conductivity (conductive substrates). In order to impart a function serving as an image-display medium to the substrates, it is necessary that at least one of the pair of substrates is a transparent conductive substrate. In this case, the transparent conductive substrate acts as a display substrate.

For use as the conductive substrate in the image-display medium, the substrates themselves may have electric conductivity, or alternatively, the surface of an insulating support may undergo electrically conducting treatment. The conductive substrate may be either crystalline or amorphous. The substrates having electric conductivity by themselves may be made of a metal such as aluminum, stainless steel, nickel or chromium, or an alloy crystal thereof; or a semiconductor made of Si, GaAs, GaP, GaN, SiC, ZnO and the like.

The insulating support may comprise a polymer film, or a glass, quartz or ceramic plate. The insulating support may be subjected to electrically conducting treatment by film-forming of the above-listed metals or gold, silver, copper or the like through vapor deposition, sputtering, ion plating or some other method.

As the transparent conductive substrate, there may be used: a conductive substrate in which a transparent electrode is formed on one surface of an insulating transparent support; or a transparent support which has electric conductivity in itself. The transparent support which has electric conductivity in itself may be made of a transparent conductive material such as indium tin oxide, zinc oxide, tin oxide, lead oxide, indium oxide or copper iodide.

The insulating transparent support to be used may be a film or a plate-shaped material made of a transparent inorganic materials such as glass, quartz, sapphire, MgO, LiF or CaF₂, or a transparent organic resin such as fluorine group-containing resin, polyester, polycarbonate, polyethylene, polyethylene terephthalate, or epoxy resin; an optical fiber; a selfoc optical plate; or the like.

As the transparent electrode formed on one face of the above-mentioned transparent support, the following may be used: a film made from a transparent conductive material such as indium tin oxide, zinc oxide, tin oxide, lead oxide, indium oxide or copper iodide by employing vapor deposition, ion plating, sputtering or some other method; or a thin film sufficient to exhibit translucency and made from a metal such as Al, Ni or Au through vapor deposition or sputtering.

Another surface of the above-mentioned substrate that is arranged opposite to the other substrate is preferably provided with a protective layer having appropriate surface conditions owing to its effect on the charge polarity of the particles. The material of the protective layer may be selected mainly from the viewpoints of adhesiveness to the substrate, transparency, tribo series, and stain-proofing properties. Specific examples of the protective layer material include polycarbonate resin, vinyl silicone resin, and fluorine-group containing resin. The usable resins are selected considering a structure of the main monomer of the particles used, and a reduced difference in frictional electrification between the resin and the particles.

-Embodiments of Image-Forming Device-

By reference to the accompanying drawings, an illustrative example of an image-forming device produced using the above-mentioned image-display medium will be described in detail hereinafter.

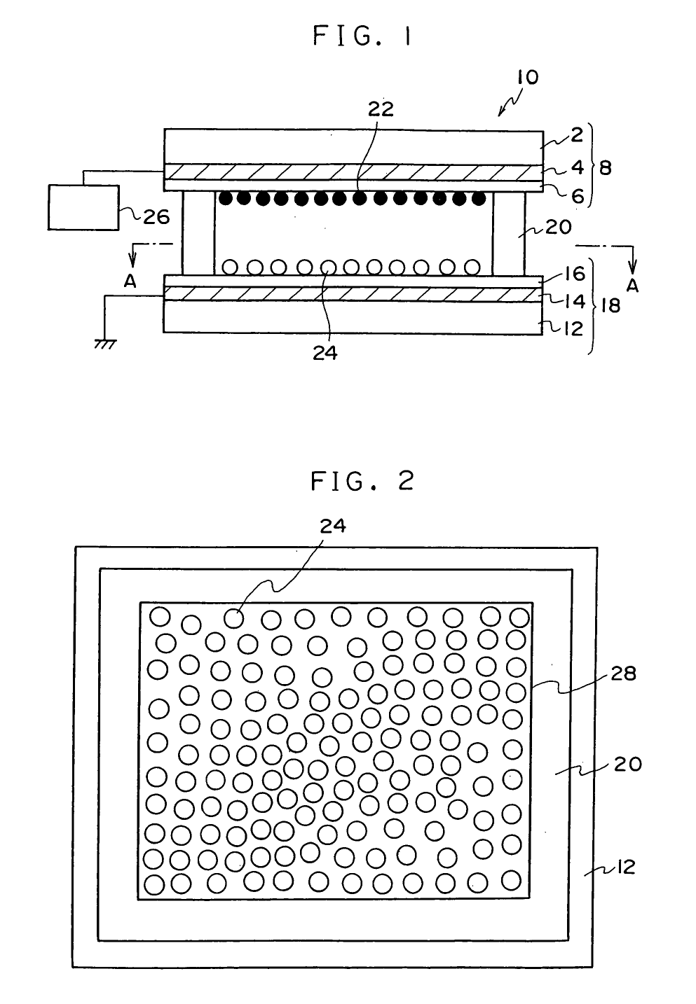

FIG. 1 is a schematic structural view of the image-forming device, and FIG. 2 is a sectional view of FIG. 1, taken along a section line A-A. The image-forming device illustrated in FIG. 1 has an image-display medium 10 and a voltage generating unit 26. The image-display medium 10 is composed of a display substrate 8, black particles 22, white particles 24, a non-display substrate 18, and a spacer 20. The display substrate 8 comprises a transparent electrode 4 and a protective layer 6, successively laminated on a surface of a transparent support 2. Similarly, the non-display substrate 18 comprises an electrode 14 and a protective layer 16, successively laminated on a surface of a support 12. The transparent electrode 4 of the display substrate 8 is connected to the voltage generating unit 26, and the electrode 14 of the non-display substrate 18 is grounded.

In the image-display medium of the invention, display device particles produced by the process for producing display device particles of the invention, which will be described later, are used as the black particles 22 and the white particles 24.

Description will be given of the image-display medium 10, by illustrating specific dimensions and constituting materials thereof. However, the structure of the image-display medium 10 is not limited to the following specific structure.

As the transparent support 2, the transparent electrode 4, the support 12 and the electrode 14, which constitute the outside of the image-display medium 10, for example, glass substrates (#7059) with a transparent electrode ITO (indium tin oxide) having a size of 50 mm×50 mm×1.1 mm are used. The support 12 and the electrode 14 on the side of the non-display substrate 18 may not be necessarily transparent. The protective layers 6 and 16, which are made of a polycarbonate resin (PC-Z) and each have a thickness of 5 μm, are formed on the inner surfaces of the glass substrates (i.e., the respective surfaces of the transparent electrode 4 and the electrode 14) and contact with the particles.

The spacer 20 is a member molded by making a square space 28 having a size of 15 mm×15 mm at the center of a silicone rubber plate with a size of 40 mm×40 mm×0.3 mm, such that an empty space can be produced when the member is set up. Arrangement of this silicone rubber plate, in which the square space 28 is provided, on the surface of the non-display substrate 18 on which the electrode 14 and the protective layer 16 are formed produces the spacer 20.

Mixed particles of the black particles 22 and the white particles 24 in an amount of about 15 mg are sieved through a screen into the empty space formed by the square space 28 produced in the spacer 20. Thereafter, the display substrate 8 is adhered closely to the spacer 20 to render the surface on which the transparent electrode 4 and the protective layer 6 are formed to face the non-display substrate 18. The two substrates 8 and 18 are held under pressure with double clips such that the spacer 20 are closely adhered to the two substrates 8 and 18, thereby forming the image-display medium 10.

Using the image-display medium 10, images are formed, for example, as follows. When a DC voltage of 150 V is first applied to the transparent electrode 4 of the display substrate 2 of the image-display medium 10 from the voltage generating unit 26, a part of the negatively-charged white particles 24 present on the side of the non-display substrate 18 begins to migrate to the display substrate 8 by the effect of an electric field generated. When a DC voltage of 500 V is applied thereto, many of the white particles 24 migrate to the side of the display electrode 8, and hence display density is substantially saturated. At this time, the positively-charged black particles 22 migrate to the side of the non-display substrate 18. Thereafter, even if the voltage applied from the voltage generating unit 26 is set into 0 V, the white particles 24 adhering to the display substrate 8 do not move, thereby not changing display density.

Illustrated above is the image-forming device using the image-display medium with reference to the drawings. However, the invention is not limited thereto. For example, as the color of the particles, white and black are exemplified. However, combinations of various colors may further be adopted. As described above, one of the colors is preferably white. The sizes of respective members are illustrated as an example, and may be selected from various sizes depending on the use purpose of each of the members.

The image-forming device of the invention comprises one image-forming device having plural image-display media in which plural cells, each of which is made of a cell composed of the above-mentioned image-display medium, are arranged in a planar shape (or the cells are individually arranged in a planar shape in the void between the substrates to face each other). By arbitrarily selecting the number of cells both in a lengthwise direction and a lateral direction, it is possible to produce an image-forming device with a large screen having a desired resolution power.

(Process for Producing Display Device Particles, and Display Device Particles)

Description will now be given of a process for producing display device particles usable in the aforementioned image-display medium and image-forming device; and display device particles produced by this production process.

The process for producing display device particles having positive or negative chargeability and having color of the present invention is a process comprising at least an emulsification step in which calcium carbonate is added as an emulsifying auxiliary to a display device particle-forming composition that contains a colorant and a polymerizable monomer or a resin, wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less.

Accordingly, it is possible to narrow down the particle size distribution of the display device particles if they are produced by the above-mentioned production process. Therefore, in case where the display device particles are used in the above-described image-display medium, it is possible to increase image contrast and to make image density uniform. Further, even if repeatedly rewriting is performed over a long term, decreases in image density, density contrast and image uniformity can be suppressed, to thereby maintain good image quality.

When conventional display device particles are used, the particle size distribution in the relatively smaller particle range is too broad and an agglomerating force between the particles is too strong. Thus, the particles cannot be sufficiently separated from each other by an electric field in the image-forming device, whereby a sufficient density contrast cannot be obtained. Further when the particle size distribution in the relatively larger particle range of the display device particles is too broad and unevenness is generated in image density, uniform display cannot be obtained. Alternatively, at the time of display, the particles collide against the display surface to thereby become deformed and adhere easily to the display screen. Thus, the particles are not separated therefrom, and hence a sufficient image density contrast cannot be obtained.

The invention has solved the above-described problems. In more detail, when the particle size distribution in the relatively smaller particle range of display device particles is too broad, the agglomerating force between the particles is too strong, the particles cannot be sufficiently separated from each other by an electric field in the image-forming device. Consequently, a sufficient density contrast cannot be obtained. Further, when the particle size distribution in the relatively larger particle range of the display device particles is too broad, unevenness is generated in image density, whereby uniform display cannot be obtained. Alternatively, at the time of display, the particles collide against the display surface to become deformed and easily adhere to the display screen. Thus, the particles are not separated therefrom, and hence a sufficient image density contrast cannot be obtained.

As described above, in order to control the particle size distribution of the display device particles produced through at least the emulsification step, it is necessary to narrow down the particle size distribution of an emulsified product generated in the emulsification step. For this purpose, it is necessary to control the dispersed particle size and the particle size distribution of calcium carbonate which is used as an emulsifying auxiliary and present in an aqueous phase. Specifically, it is necessary that the average dispersed particle size of the emulsifying auxiliary in an aqueous medium is in the range of from 0.05 to 1 μm, and the variation coefficient of the dispersed particle sizes is 60% or less.

If the average dispersed particle size of the emulsifying auxiliary in the aqueous medium is less than 0.05 μm, an amount of particles in the relatively smaller particle range of the finally-obtained display device particles increases due to an excessively strong emulsifying effect, thus failing to obtain a sharp particle size distribution. On the other hand, if the average dispersed particle size is more than 1 μm, an amount of particles in the relatively larger particle range of the display device particles increases, thus failing to obtain a sharp particle size distribution. In order to make the particle size distribution sharp, it is preferable to specify the average dispersed particle size of the emulsifying auxiliary present in the aqueous medium within a range of from 0.1 to 0.8 μm.

If the variation coefficient of the dispersed particle size of the emulsifying auxiliary is more than 60%, the particle size distribution of the finally-obtained display device particles does not become sharp because the amounts of particles on both of the relatively smaller and larger particle ranges are large. The variation coefficient of the dispersed particle sizes of the emulsifying auxiliary is preferably 45% or less.

As used herein, the average dispersed particle size of the emulsifying auxiliary in the aqueous medium, and the variation coefficient of the dispersed particle sizes (standard deviation of the dispersed particle sizes/average dispersed particle size) refers to values that are measured, on volume basis, using a laser diffracting/scattering type particle size distribution measuring device LA 920 (manufactured by Horiba Ltd.).

As described above, in order to control the average dispersed particle size of the emulsifying auxiliary in the aqueous medium and the variation coefficient of the dispersed particle sizes, it is necessary to coat calcium carbonate used as the emulsifying auxiliary with a hydrophilic organic material. In case where calcium carbonate is used as it is as the emulsifying auxiliary as performed in the prior art, it is impossible to control the average dispersed particle size of the emulsifying auxiliary in an aqueous medium and the variation coefficient of the dispersed particle sizes to fall within the above-mentioned range.

As the hydrophilic organic material, a known hydrophilic macromolecular compound or low molecular weight compound having a hydrophilic group such as a carboxyl group or a hydroxyl group can be used. The hydrophilic group may be in the form of a salt thereof.

Examples of such a hydrophilic organic material include polyvinyl alcohol; hydrophilic polymers obtained by polymerizing a monomer having a hydrophilic group, such as acrylic acid or maleic acid; copolymers thereof; and mixtures thereof. In the invention, it is preferable to use, among these listed above, a polymer (hydrophilic polymer) containing a carboxyl group, as the hydrophilic organic material.

The degree of the hydrophilicity of these hydrophilic organic materials is not particularly limited. It is preferable to specify a contact angle of the film made of the hydrophilic organic material to water to be 60 degrees or less.

The coating amount of the hydrophilic organic material applied on the surface of calcium carbonate is not particularly limited, but preferably specified in the range of 0.3 to 5% by weight. If the coating amount is less than 0.3% by weight, it may be impossible to control the average dispersed particle size of the emulsifying auxiliary in the aqueous medium and the variation coefficient of the dispersed particle sizes within the above-mentioned range. If the coating amount is more than 5% by weight, the particle size and particle size distribution of the emulsified product when using the emulsifying auxiliary may not be sufficiently controlled.

It is desirable, in the emulsification step, to use calcium carbonate coated with the hydrophilic organic material in an amount of 2 to 100% by weight of the display device particle-forming composition comprising a colorant and a polymerizable monomer or a resin.

If the amount is smaller than the lower limit of this range, the particle size of the finally-obtained display device particles is liable to become large. On the other hand, if the amount is larger than the upper limit, the particle size of the finally-obtained display device particles is liable to become small. As a result, a good image may not be formed.

It is also preferable to use, in combination with the emulsifying auxiliary, a known anionic, nonionic or cationic surfactant, or a polymer dispersing agent such as polyvinyl alcohol, polyvinyl pyrrolidone, gelatin, methylcellulose, polyacrylic acid, starch or casein, as an emulsifying auxiliary aid.

If necessary, a solvent may be used to dissolve the resin which constitutes the display device particles. The solvent is desirably a water-immiscible solvent in which the resin is soluble. Specific examples thereof include ester solvents such as methyl acetate, ethyl acetate, propyl acetate and butyl acetate; ether solvents such as diethyl ether, dibutyl ether and dihexyl ether; ketone solvents such as methyl ethyl ketone, methyl isopropyl ketone, methyl isobutyl ketone, and cyclohexanone; hydrocarbon solvents such as toluene and xylene; and halogenated hydrocarbon solvents such as dichloromethane, chloroform, and trichloroethylene. It is preferable that these solvents can dissolve a polymer and solubility thereof in water (by percentage) ranges from about 0 to 30% by weight.

The shape of the display device particles obtained by the display device particle production process of the invention is desirably as completely spherical as possible. By making the shape of the display device particles as completely spherical as possible, a contacting state between the particles can be substantially made into a point contact and the contacting state between the display device particles and the substrate surface of the image-display medium can also be substantially made into a point contact. Consequently, adhesiveness between the particles and between the particles and the substrate surface, based on van der Waals force therebetween, becomes low.

Therefore, even if the substrate surface of the image-display medium is made of a dielectric substance, the charged particles can move smoothly within the substrate via an electric field. Furthermore, if the particles are in the shape of complete spheres, deformation and adhesion of the particles caused when the particles collide against the display surface can easily be prevented.

The display device particle production process of the invention may be any display device particle production process, insofar as the process comprises at least an emulsification step as described above. Specifically, a wet-type production process may be employed which comprises an emulsification step, such as an emulsification polymerization process that is known as a process for producing an electrophotographic toner.

The device used in the emulsification step may be any device that is generally commercially available as an emulsifier or a classifier. Examples thereof include batch-type emulsifiers such as an ULTRA-TURRAX manufactured by IKA Japan K.K., a POLYTRON manufactured by Kinematica AG, a TK AUTO HOMOMIXER manufactured by Tokushu Kika Kogyo Co., Ltd., and a NATIONAL COOKING MIXER manufactured by Matsushita Electric Industrial Co., Ltd.; continuous-type emulsifiers such as an EBARA MILDER manufactured by Ebara Corp., a TK PIPE LINE HOMOMIXER and a TK HOMOMIC LINE FLOW manufactured by Tokushu Kika Kogyo Co., Ltd., a colloid mill manufactured by Shinko Pantec Co., Ltd., a slasher, a trigonal wet-type pulverizer manufactured by MITSUI MIIKE CHEMIKAL INDUSTRY CO., LTD., a CAPITRON manufactured by Eurotec, Ltd., and a FINE FLOW MILL manufactured by Pacific Machinery & Engineering Co., Ltd.; emulsifiers usable as both of batch- and continuous-types, such as a CREAMIX manufactured by M Technique Co., Ltd., a FILMIX manufactured by Tokushu Kika Kogyo Co., Ltd.; high-pressure emulsifiers such as a MICROFLUIDIZER manufactured by Mizuho Industrial Co., Ltd., a NANOMAKER, a NANOMIZER manufactured by Nanomizer Co., an APV GAULIN manufactured by Gaulin Co.; membrane emulsifiers such as a membrane emulsifier manufactured by REICA Co., Ltd.; vibration-type emulsifiers such as a VIBROMIXER manufactured by REICA Co., Ltd.; and ultrasonic emulsifiers such as an ultrasonic homogenizer manufactured by Pranson Co.

Specifically, the emulsification step can be performed as follows in the invention. First, the following components are prepared: an oil-phase display device particle-forming composition in which a resin (or a polymerizable monomer), a colorant, optionally a charge controlling agent, optionally a polymerization initiator, or other components are dissolved or dispersed in a monomer or a solvent; and aqueous materials to constitute an aqueous phase (i.e., water, and calcium carbonate coated with a hydrophilic organic material, which is used as an emulsifying auxiliary).

Next, the oil-phase display device-forming composition and the aqueous phase composition are emulsified using an emulsifier as listed above, to thereby yield particles having desired particle sizes. The emulsifying rate in the emulsification step desirably ranges from 5 to 30 m/s. If the emulsifying rate is smaller than the lower limit of this range, the particle size of the emulsified particles is liable to become large. On the other hand, if the emulsifying rate is larger than the upper limit, the particle size of the emulsified particles is liable to become small. Both the cases are not preferable.

In case where a polymerizable monomer is used, instead of the resin, for producing the display device particles, the oil-phase display device particle-forming composition is prepared, after which the polymerizable monomer is polymerized. Incidentally, when the solvent is used in the process, it is then removed.

After the emulsification step is complete, it is desirable to perform a step of decomposing calcium carbonate coated with the hydrophilic organic material, which is used as the emulsifying auxiliary, by use of an acid, to thereby remove calcium carbonate from a solution containing the emulsified product (particles). If the calcium carbonate remains in the emulsion, disadvantageous effects may be exerted on the charging characteristic of the finally-obtained display device particles. After this step is completed, the emulsified product is dried in a usual way, to thereby yield the display device particles of the invention.

-Constituting Materials of Display Device Particles-

The display device particles produced by the display device particle production process of the invention comprises at least a colorant and a resin. The display device particles may further comprise a charge controlling agent and other components, as necessary. The colorant may share a function serving as a charge controlling agent. The colorants used in the invention are exemplified below.

Examples of the black colorant include carbon black, titanium black, magnetic powder, oil black, and organic or inorganic black dyes or pigments.

Examples of the white colorant include rutile type titanium oxide, anatase type titanium oxide, zinc white, lead white, zinc sulfide, aluminum oxide, silicon oxide, and zirconium oxide. Among these, rutile type titanium oxide is particularly preferable.

Examples of the colorant having other colors include phthalocyanine type, quinacridon type, azo type, condensed type, insoluble lake pigment, and inorganic oxide type dye or pigments. Representative examples thereof include Aniline Blue, Calconyl Blue, chromium yellow, ultramarine blue, Du Pont Oil Red, Quinoline Yellow, methylene blue chloride, Phthalocyanine Blue, malachite green oxalate, lamp black, Rose Bengal, C. I. Pigment Red 48:1, C. I. Pigment Red 122, C. I. Pigment Red 57:1, C. I. Pigment Yellow 97, C. I. Pigment Yellow 180, C. I. Pigment Yellow 185, C. I. Pigment Blue 15:1, and C. I. Pigment Blue 15:3.

Examples of the structure of the colorant which may function as a charge controlling agent include a structure having an electron withdrawing group, a structure having an electron donating group, and a metal complex structure. Specific examples of the colorant include C. I. Pigment Violet 1, C. I. Pigment Violet 3, C. I. Pigment Black 1, and C. I. Violet 23.

Examples of the resin, which constitute the display device particles, include polyvinyl resins such as polyolefin, polystyrene, acrylic resin, polyacrylonitrile, polyvinyl acetate, polyvinyl alcohol, polyvinyl chloride, and polyvinyl butyral; vinyl chloride/vinyl acetate copolymer; styrene/acrylic acid copolymer; straight silicone resins having organosiloxane bonds, and modified products thereof; fluorine group-containing reins such as polytetrafluoroethylene, polyvinyl fluoride, and polyvinylidene fluoride; polyester; polyurethane; polycarbonate; amino resins; and epoxy resins. These resins may be used alone or in combination thereof. These resins may be crosslinked. A conventionally known binder resin, which is known as a main component of conventional electrophotographic toner, can be used in the display device particles without any problem.

If necessary, a charge controlling agent may be added to the display device particles in order to regulate charging characteristics. As the charge controlling agent, any known charge controlling agent employed in conventional electrophotographic toner can be used. Examples thereof include cetylpyridium chloride; BONTRON P-51, BONTRON P-53, BONTRON E-84, and BONTRON E-81 each of which is manufactured by Oriental Chemical Industries Ltd.); quaternary ammonium salts such as COPY CHARGE PSY VP2038 (manufactured by Clariant (Japan) K.K.); salicylic acid metal complexes; phenolic condensates; tetraphenolic compounds; metal oxide particles; and metal oxide particles having surface-treated with various coupling agents.

### EXAMPLES

The present invention will now be described in more detail by way of the examples. In the following Examples and Comparative Examples, an image forming medium and an image-forming device shown in FIGS. 1 and 2 are used to confirm the effects of the invention by changing the structure of white particles and that of black particles. In the examples, sizes, materials and other items of respective members are selected to have the same features as described specifically with reference to FIGS. 1 and 2.

<Production of Display Device Particles>

As display device particles, white particles and black particles are separately produced in the following manner.

1) Production of White Particles

a) Preparation of Dispersion A

Styrene monomer: 150 parts by weight
Titanium oxide (TAIPAKE CR63, manufactured by Ishihara Sangyo Kaisha, Ltd.): 90 parts by weight
Charge controlling agent (COPY CHARGE PSY VP 2038, manufactured by Clariant (Japan) K.K.): 3 parts by weight
Polymerization initiator AIBN (azoisobutyronitrile): 3 parts by weight

A mixture of the above-indicated composition is subjected to ball mill pulverization using zirconia balls of 100 mmφ diameter for 20 hours to thereby prepare a dispersion A.

b) Preparation of Calcium Carbonate Dispersions B1 to B4

Calcium carbonate (primary average particle size: 80 nm) coated with an acrylic acid/maleic acid copolymer (1% by weight) having an ammonium salt structure of a carboxylic group (number average molecular weight: 4000): 30 parts by weight
Water: 70 parts by weight

A mixture of the above-indicated composition is subjected to ball mill pulverization at 30 rpm for 3 days to thereby give a calcium carbonate dispersion B1.

Additional calcium carbonate dispersions B2, B3 and B4 are prepared in a similar manner to the preparation of the calcium carbonate dispersion B1, except that the dispersing times are set into 1 day, 10 days and 10 hours, respectively.

c) Preparation of Calcium Carbonate Dispersion B5

Calcium carbonate (primary average particle size: 80 nm): 30 parts by weight
Water: 70 parts by weight

A mixture of the above-indicated composition is subjected to ball mill pulverization at 30 rpm for 3 days to thereby prepare a calcium carbonate dispersion B5.

d) Preparation of Dispersion C

Calcium carbonate dispersion B1: 18 parts by weight
20% Salt water: 50 parts by weight

A mixture of the above-indicated composition is stirred using an emulsifier (ULTRA-TURRAX) at 20 m/s for 1 minute to thereby yield a dispersion C1.

Additional dispersion solutions C2, C3, C4 and C6 are prepared in a similar manner to the preparation of the dispersion C1, except that, instead of the calcium carbonate dispersion B1, 40 parts by weight of the calcium carbonate dispersion B2, 2 parts by weight of the calcium carbonate dispersion B3, 130 parts by weight of the calcium carbonate dispersion B4, and 200 parts by weight of the calcium carbonate dispersion B5 are used, respectively.

A dispersion C5 is prepared in a similar manner to the preparation of the dispersion C1, except that 35 parts by weight of the calcium carbonate dispersion B1 is used and no stirring using the emulsifier (ULTRA-TURRAX) is provided. An average dispersed particle size each of the resultant dispersions C1 to C6 and a variation coefficient of the dispersed particle sizes are shown in Table 1.

e) Preparation of Emulsion D

Thirty parts by weight of the dispersion A is added to each of the resultant dispersions C1, C2, C3, C4, C5 and C6, and then the resultant mixtures are subjected to emulsification using the emulsifier (ULTRA-TURRAX) at 20 m/s for 3 minutes. As a result, emulsions D1, D2, D3, D4, D5 and D6 are prepared.

f) Production of Particles E

Each of the resultant emulsions D1, D2, D3, D4, D5 and D6 is heated to 70° C. under nitrogen gas flow and stirred for 20 hours to cause polymerization, to thereby produce solid particles.

Then, 35% hydrochloric acid is added to the emulsions D1, D2, D3, D4, D5 and D6 after having undergone heat treatment, in amounts of 15, 33, 2, 110, 30 and 200 parts by weight, respectively. The resultant mixtures are stirred to dissolve calcium carbonate, and then subjected to suction filtration, followed by washing with water 5 times. Thereafter, the resultant products are dried to give white particles E1, E2, E3, E4, E5 and E6.

2) Production of Black Mother Particles

Styrene monomer: 90 parts by weight
Carbon black: 10 parts by weight

Polymerization initiator AIBN (azoisobutyronitrile): 1 part by weight Black particles F1 are produced in a similar manner to the production of the white particles E1, except that a dispersion A′ having the above-indicated components is used instead of the dispersion A for the production of the white particles.

TABLE 1

| | Average Dispersed | Variation Coefficient | |
|---|---|---|---|
| | Particle Size | (%) | Calcium Carbonate |
| Dispersion C1 | 0.25 | 40 | Coated with hydrophilic material |
| Dispersion C2 | 0.70 | 43 | Coated with hydrophilic material |
| Dispersion C3 | 0.04 | 38 | Coated with hydrophilic material |
| Dispersion C4 | 1.50 | 42 | Coated with hydrophilic material |
| Dispersion C5 | 0.35 | 65 | Coated with hydrophilic material |
| Dispersion C6 | 3.75 | 73 | Not coated with hydrophilic material |

The particle sizes of the produced white particles and black particles and the particle size distribution thereof are shown in Table 2. In Table 2, D16v represents the particle size obtained at a point of 16% that is calculated from the largest particle size of the volume-based particle sizes, and D50v represents the particle size obtained at a point of 50% that is calculated from the largest particle size of the volume-based particle sizes. D50p represents the particles size obtained at a point of 50% that is calculated from the largest particle size of the number-based particle sizes, D84v represents the particle size obtained at a point of 84% that is calculated from the largest particle size of the volume-based particle sizes, and D84p represents the particle size obtained at a point of 84% that is calculated from the largest particle size of the number-based particle sizes.

D16v/D50v is an index of the particle size distribution in the relatively larger particle range. The smaller the value, the narrower the particle size distribution. When a value of 1 is obtained, the particle size distribution is revealed mono-disperse. D84p/D50p is an index of the particle size distribution in the relatively smaller particle range. The smaller the value, the narrower the particle size distribution. When a value of 1 is obtained, the particle size distribution is revealed mono-disperse. \sqrt{D16v/D84v} is an index of the particle size distribution of all the particles. The smaller the value, the narrower the particle size distribution. When a value of 1 is obtained, the particle size distribution is revealed mono-disperse. These values may be obtained by measuring the particle sizes using, for example, a measuring device, MULTISIZER II (manufactured by Beckman Coulter, Inc.).

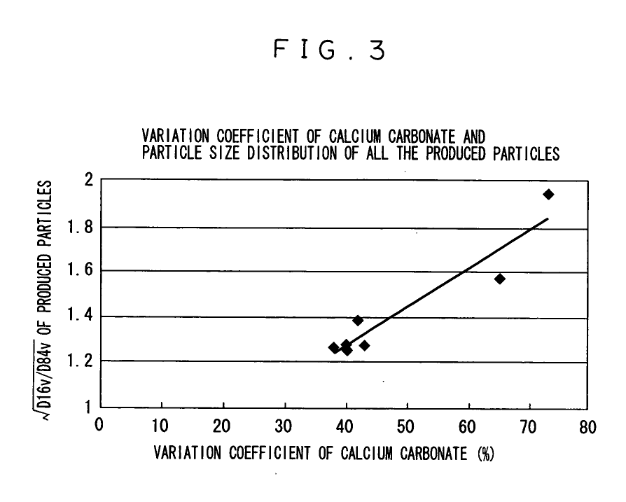

From the results of the variation coefficient of calcium carbonate and the values of \sqrt{D16v/D84v} summarized in Table 2, a graph is obtained as shown in FIG. 3, with \sqrt{D16v/D84v} as ordinate and variation coefficient as abscissa. This graph indicates that with respect to all the particles, a range less than 1.6 of the particle size distribution is preferable, and this can be realized by making the variation coefficient of calcium carbonate less than 60%.

TABLE 2

| | | Calcium Carbonate/ | | | | |
|---|---|---|---|---|---|---|
| | | Display Device Particle- | | | | |
| | | Forming Composition | | | | |
| | Dispersion | (weight ratio) | D50v (μm) | D16v/D50v | D84p/D50p | \sqrt{D16v/D84v} |
| White Particles E1 | Dispersion C1 | 18% | 14.5 | 1.25 | 1.90 | 1.26 |
| White Particles E2 | Dispersion C2 | 40% | 15.3 | 1.30 | 1.80 | 1.28 |
| White Particles E3 | Dispersion C3 | 2% | 17.8 | 1.29 | 2.75 | 1.27 |
| White Particles E4 | Dispersion C4 | 130% | 11.2 | 1.40 | 1.95 | 1.39 |
| White Particles E5 | Dispersion C5 | 35% | 14.3 | 1.45 | 2.45 | 1.58 |
| White Particles E6 | Dispersion C6 | 200% | 35.0 | 2.10 | Impossible to | 1.95 |
| | | | | | Measure | |
| Black Particles F1 | Dispersion C1 | 18% | 14.0 | 1.27 | 1.85 | 1.28 |

<Preparation of Mixed Particles>

Each of the produced white particles of various kinds is blended with the black particles F1, and then admixed to prepare mixed particles for use in Examples and Comparative Examples. At this time, a blending ratio (by weight) of the white particles relative to the black particles is specified to be 3:2. The mixture is subjected to vibratory stirring by hand to provide electric charges, to thereby obtain mixed particles. The white particles are positively charged and the black particles are negatively charged.

<Production of Image-Display Medium>

Each of the mixed particles of various kinds as produced above is sealed into a void between the substrates arranged to face each other (i.e., a display substrate 8 and a non-display substrate 18), and then an image-forming device using the image-display medium 10 is produced in a usual manner. A voltage of 500 V is applied between a transparent electrode 4 and an electrode 14 of the resultant image-forming device, to function as a desired electric field onto the group of the particles that are present between the display substrate 8 and the non-display substrate 18, whereby the respective particles 22 and 24 migrate between the display substrate 8 and the non-display substrate 18. By switching over polarity of the applied voltage, the different kinds of the particles 22 and 24 move in mutually different directions between the display substrate 8 and the non-display substrate 18. By switching over voltage polarity repeatedly, the different kinds of particles reciprocate between the display substrate 8 and the non-display substrate 18. Through this process, the particles 22 and the particles 24 are further electrified to have different polarities by collision between the particles 22, between the particles 24, and between the particles 22 or 24 and the display substrate 8 or the non-display substrate 18.

In the image-forming device as produced above, the white particles are positively charged and the black particles are negatively charged, whereby the two kinds of particles move to directions different from each other depending on the electric field generated between the display substrate 8 and the non-display substrate 18. When the direction of the electric field is fixed on either one of the two directions, each of the two kinds of particles 22 and 24 adheres to the display substrate 8 or the non-display substrate 18, to thus form an image.

<Evaluating Test>

In the image-forming device using the above-produced mixed respective kinds of particles, polarity of the voltage is switched over every one second to render the two kinds of particles 22 and 24 to move to different directions between the display substrate 8 and the non-display substrate 18 every one second. This switchover is repeated 1,000 cycles to make the image-display device set on an initial state. In this case, a difference between image density generated when the white particles migrate to the display screen side, and image density generated when the black particles migrate thereto is defined as contrast. The resultant image is measured for density using a Macbeth densitometer. When a density difference is 0.7 or more, it is rated to have a sufficient contrast. The image is also evaluated for uniformity visually. When the image does not reveal uneveness, it is rated to have uniformity.

Then, polarity of the voltage is switched over every 0.1 second, and this switchover is repeated 100,000 cycles to display an image. The obtained image is evaluated for density contrast and uniformity in a similar manner as performed in the initial state. The results are shown in Table 3.

TABLE 3

| | | Initial Image Quality | | Image Quality after Display | | Total |
|---|---|---|---|---|---|---|
| | White Particles | Contrast | Uniformity | Contrast | Uniformity | Assessment |
| Example 1 | White Particles E1 | 0.72 | ◯ | 0.71 | ◯ | ◯ |
| Example 2 | White Particles E2 | 0.74 | ◯ | 0.72 | ◯ | ◯ |
| Comparative Example 1 | White Particles E3 | 0.58 | ◯ | 0.55 | ◯ | X |
| Comparative Example 2 | White Particles E4 | 0.72 | X | 0.60 | X | XX |
| Comparative Example 3 | White Particles E5 | 0.62 | X | 0.51 | X | XX |
| Comparative Example 4 | White Particles E6 | Impossible to | XX | Impossible to | — | XX |
| | | Measure | | Measure | | |

As seen from the results shown in Table 3, in Examples which use the display device particles, with respect to both the white particles and the black particles, that are produced by the production process of the invention, the obtained images are good in both density contrast and uniformity, and image deterioration after the 100,000 cycle display is considerably small. On the other hand, in Comparative Examples which use the display device particles produced without employing the production process of the invention for the white particles, the obtained images are inadequate in density contrast and uniformity. Further, the images are deteriorated after the 100,000 cycle display.

As detailed above, the present invention provides a process for producing display device particles having a narrow particle size distribution, display device particles obtained by this production process, as well as an image-display medium and an image-forming device using the display device particles.

1. A process for producing display device particles having positive or negative chargeability and having color, comprising:
at least an emulsification step in which calcium carbonate is added as an emulsifying auxiliary to a display device particle-forming composition that contains at least a colorant and a polymerizable monomer or a resin,
wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less.

2. The process for producing display device particles according to claim 1, wherein the hydrophilic organic material is a polymer having a carboxyl group.

3. The process for producing display device particles according to claim 1, wherein the emulsifying auxiliary is added in an amount ranging from 2 to 100% by weight of the display device particle-forming composition.

4. The process for producing display device particles according to claim 1, wherein the emulsifying rate during the emulsification step ranges from 5 to 30 m/s.

5. The process for producing display device particles according to claim 1, wherein the emulsifying auxiliary is removed from the emulsified product obtained through the emulsification step.

6. Display device particles having positive or negative chargeability and having color, produced through at least an emulsification step in which calcium carbonate is added as an emulsifying auxiliary to a display device particle-forming composition that contains at least a colorant and a polymerizable monomer or a resin,
wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less.

7. The display device particles according to claim 6, wherein the hydrophilic organic material is polyvinyl alcohol.

8. An image-display medium comprising a pair of substrates arranged to face each other and particle groups made up of two or more kinds of particles and sealed in a void between the pair of substrates, in which at least one of the particle groups has positive chargeability, at least one of the other particle groups has negative chargeability, and the at least one of the former particle groups and the at least one of the latter particle groups have mutually different colors,
wherein the particles having positive and negative chargeability are produced through at least an emulsification step in which calcium carbonate is added as an emulsifying auxiliary to a display device particle-forming composition that contains at least a colorant and a polymerizable monomer or a resin, and
wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less.

9. The image-display medium according to claim 8, wherein a material for the substrates is selected from the group consisting of aluminum, stainless steel, nickel, chromium, alloy crystals thereof, Si, GaAs, GaP, GaN, SiC, and ZnO.

10. The image-display medium according to claim 8, wherein the substrates are produced by subjecting to an electrically conducting treatment an insulating material selected from the group consisting of a polymer film, glass, quartz and ceramics.

11. The image-display medium according to claim 8, wherein the substrates comprise a transparent conductive material selected from the group consisting of indium tin oxide, zinc oxide, tin oxide, lead oxide, indium oxide, and copper iodide.

12. The image-display medium according to claim 8, wherein the substrates have disposed thereon protective layers made of a material selected from the group consisting of polycarbonate resin, vinyl silicone resin and fluorine-group containing resin.

13. The image-display medium according to claim 8, wherein the particles having positive or negative chargeability have a central particle size ranging from 3 to 30 μm.

14. An image-forming device for forming an image in an image-display medium comprising a pair of substrates arranged to face each other and particle groups made up of two or more kinds of particles and sealed in a void between the pair of substrates, in which at least one of the particle groups has positive chargeability, at least one of the other particle groups has negative chargeability, and the at least one of the former particle groups and the at least one of the latter particle groups have mutually different colors,
wherein the particles having positive and negative chargeability are produced through at least an emulsification step in which calcium carbonate is added as an emulsifying auxiliary to a display device particle-forming composition that contains at least a colorant and a polymerizable monomer or a resin,
wherein the emulsifying auxiliary is calcium carbonate coated with a hydrophilic organic material, an average dispersed particle size of the emulsifying auxiliary present in an aqueous medium ranges from 0.05 to 1 μm, and a variation coefficient of the dispersed particle sizes is 60% or less, and
wherein an electric field generating unit is provided in order to generate in the void between the pair of substrates an electric field corresponding to the image.
